(19) United States
(12) Patent Application Publication
(10) Pub. No.: US 2005/0105540 A1
(43) Pub. Date: May 19, 2005

(54) Method for transmitting the subscriber signaling of an analog connection of the public telephone network in an ip network

(76) Inventors: Thomas Baumann, Holzkirchen (DE); Jorg Bohmer, Berlin (DE)

Correspondence Address: Siemens Corporation;Intellectual Property Department, 170 Wood Avenue South, Iselin, NJ, 08830, US

(21) Appl. No.: 10/507,650

(22) PCT Filed: Mar. 3, 2003
(86) PCT No.: PCT/DE03/00717

(30) Foreign Application Priority Data
Mar. 20, 2002 (DE) 102 12 378.0

(51) Int. Cl. H04L 12/56

(52) U.S. Cl. 370/401

(57) ABSTRACT

The invention relates to a method for transmitting the subscriber signaling of an analog connection of the public telephone network in an IP network, which is connected to said public telephone network via a media gateway. According to said method, FSK signals are used for the subscriber signaling in the public telephone network and said signals are transmitted in the IP network in the media gateway control protocol, which is modified by a “signal requests parameter”.

### CROSS REFERENCE TO RELATED APPLICATIONS

This application is the US National Stage of International Application No. PCT/DE03/00717, filed Mar. 3, 2003 and claims the benefit thereof. The International Application claims the benefits of German application No. 10212378.0 filed Mar. 20, 2002, both of the applications are incorporated by reference herein in their entirety.

### FIELD OF INVENTION

The invention relates to a method for transmitting the subscriber signaling of an analog connection of the public telephone network in an IP network and to the structure of this network.

### BACKGROUND OF INVENTION

If you wish to connect subscribers of the public telephone network with analog access lines via what is known as a Media Gateway to an IP backbone in accordance with the prior art, you must also provide them with the IN services offered in the public telephone network. Examples of such services include “Calling Line Identification Presentation (CLIP)” to display the number of the calling subscriber, but also other IN services such as “Calling Party Name Presentation (CNIP)”, “Advice of Charge (AOC)”, Short Message Service (SMS) and “Message Waiting Indication (MWI)”.

This signaling is normally transmitted in the public telephone network in the form of FSK signals in accordance with the European Telecommunications Standard ETSI ETS 300 659 which however, as well as the services mentioned above, can also include further information about the call, such as for example the presence of a call diversion or the type of call.

The Media Gateway Control protocol as per RFC2705 is provided for transmission of the information relating to subscriber signaling of analog connections of the public telephone network in IP networks.

The disadvantage of this gateway is however it that there is as yet no option provided for transmission via the Media Gateway Control Protocol of the FSK signals normally used for subscriber signaling in the public telephone network.

### SUMMARY OF INVENTION

The object of the invention is thus to develop the prior art so as to make available a simple and effective method for transmitting the subscriber signaling of an analog connection of the public telephone network in an IP network using the Media Gateway Control Protocol.

This object is achieved by the claims.

The major idea included in the invention is that of modifying the existing Standard of the Media Gateway Control Protocol as per RFC2705 by a specially encoded “Signal Requests Parameter”. The invention proposes to use the “Analog Display Service Interface (adsi)” signal, which is provided in the Media Gateway Control Protocol as per RFC2705 for transmission of FSK signals, but is not specified there, as part of the “Signal Requests Parameter”.

A further significant point relates to the embodiment of the adsi signal, which in the specification in accordance with the invention consists of two parameters, each of which is formed from the character strings specified. The first character string specified consists of one character and characterizes the alerting method. For character “0” the transfer of the FSK signals does not require any alerting sequence, and it is valid for the transfer of an FSK signal during the ringing cadency. For character “D” FSK signaling by means of the DT-AS alerting sequence is involved and for “P” FSK signaling by means of the RP-AS alerting sequence. Finally the adsi signal can contain the character “F” in the first character string specified which is used to transfer an FSK signals during the call.

The second character string specified contains the complete message of the FSK data link layer, beginning with the field “message type”. Since the message of the FSK data link layer has a binary format, but the Media Gateway Control Protocol is by contrast ASCII text oriented, each byte of the FSK data link layer is encoded as a hexadecimal character.

A major advantage of the invention lies in the fact that, with introduction of a single coded “Signal Requests Parameter”, the information for the different FSK signaling, such as CLIP, CNIP, etc. can now be transmitted in the Media Gateway Control Protocol in an IP network in a simple way. In addition supplementary information, such as the presence of a call diversion for example or the type of call, can likewise be effectively transferred with the specified signal adsi. Also especially advantageous is the fact that through the encoding the existing software base can continue to be used largely unchanged.

Further advantageous embodiments of the invention are produced by the dependent claims.

The invention is described below on the basis of an exemplary embodiment which is explained in greater detail with reference to the Figures. The Figures show:

### BRIEF DESCRIPTION OF THE DRAWINGS

FIG. 1a the message format of an FSK data link layer,

FIG. 1b the message format of the FSK presentation layer,

FIG. 2 an MGCP encoding of an FSK signal,

FIG. 3 the structure of a network,

FIG. 4 the first part of an embodiment of the invention,

FIG. 5 the second part of an embodiment of the invention,

FIG. 6 the third part of an embodiment of the invention and

FIG. 7 the fourth part of an embodiment of the invention.

### DETAILED DESCRIPTION OF INVENTION

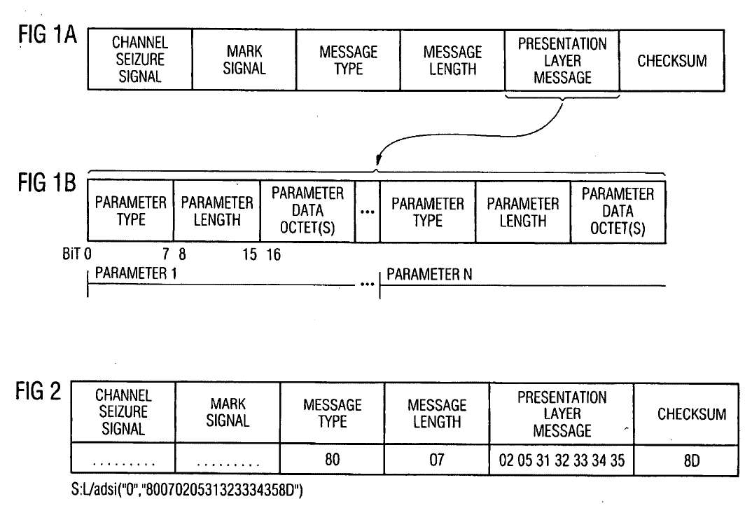

FIG. 1a shows the message format of the FSK data link layer in accordance with the prior art The data link layer is responsible for line activation/deactivation, transmission control, transmission error monitoring, clock synchronization and selection of the suitable transmission path from a number of available physical transmission paths. One part of the message of the data link layer is the message of the presentation layer, shown in FIG. 1a as “Presentation Layer Message” and shown schematically in FIG. 1b. The presentation layer specifies the format and the sequence of information which is forwarded from the subscriber switching center to a terminal. These messages just described are transmitted in an embodiment of the invention, which is shown in FIG. 2, in the MGCP format in an IP network.

FIG. 2 shows an example of a message of the FSK data link layer for the alerting method “0”, i.e. no alerting sequence is required for transferring an FSK signal during the ringing cadency. The table follows the illustration shown in FIG. 1a and shows the binary message of the FSK-data link layer. This representation produces for the encoded Signal Requests parameter of the MGCP the form shown below with the signal adsi which contains the two character strings mentioned above, the alerting method and the complex message of the data link layer, beginning with the field “message type”.

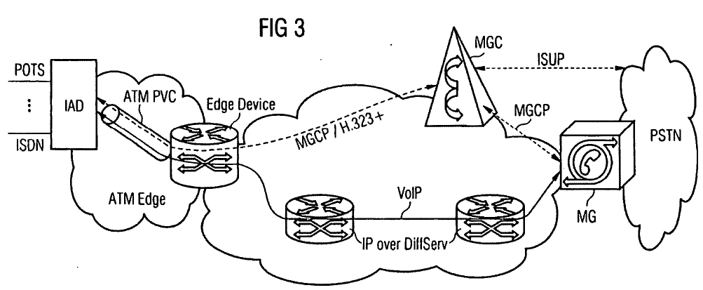

FIG. 3 shows the structure of a specific from of an IP network, a Voice-over-IP network. In this case both analog connections, symbolized by the abbreviation POTS, and also digital connections (ISDN) lead to an Integrated Access Device (IAD) which forms the interface to an ATM node, which in its turn is connected via an Edge Device with an IP network which is not described in any greater detail Between the IAD and Edge Device there is a data connection in the form of an ATM-PVC via which both the signaling, represented by a dashed double-ended arrow and also the voice (VoIP, shown as a solid double-ended arrow) is transmitted.

The signaling is transferred in H.323 or MGCP format to a Media Gateway Controller (MGC) while the voice is transmitted via various servers (IP over DiffServ) as far as a Media Gateway (MG), which forms the interface to a public switched telephone network (PSTN). The signaling can be transferred directly from the MGC into the PSTN by means of ISUP. The Media Gateway is controlled from the MGC by means of the MGCP protocol.

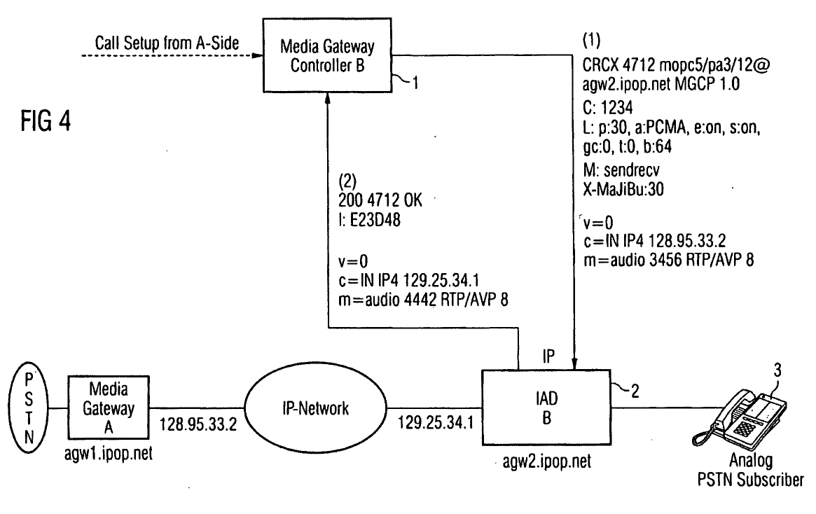

FIGS. 4 to 7 present an exemplary embodiment of the invention for transmission of the FSK signaling “Calling Line Identification Presentation (CLIP). Communication between the Media Gateway Controller (MGC) 1 and the Media Gateway, in this case an Integrated Access Device (IAD) 2, in the form of the Media Gateway Control Protocol (MGCP) in accordance with the invention is undertaken with the corresponding encoded “Signal Requests Parameter” in the form of the adsi signal.

In FIG. 4 an incoming call is received by MGC 1 and consequently in step (1) the command Create Connection is sent to the IAD 2 to set up a connection. The IAD 2 acknowledges this command in step (2).

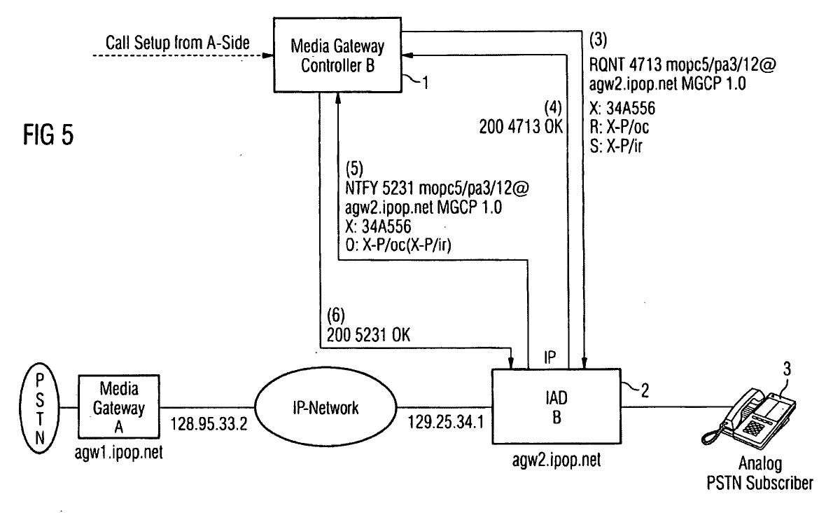

Then, referring to FIG. 5, a Notification Request is transferred to IAD 2 from MGC 1 with step (3), which contains the Initial Ring signal and the Operation Complete event. The Initial Ring signal specifies that the IAD 2 is to apply a (generally abbreviated) initial ring tone, whereas the Operation Complete event includes the information that the MGC 1 is to be notified after the completion of the event. In step (4) IAD 2 acknowledges the Notification Request (3) and, after the Initial Ring signal has been applied to the analog subscriber line 3, i.e. a connected telephone has rung for the first time, sends the Operation Complete message to MGC 1 in step (5), for which receipt is acknowledged in step (6).

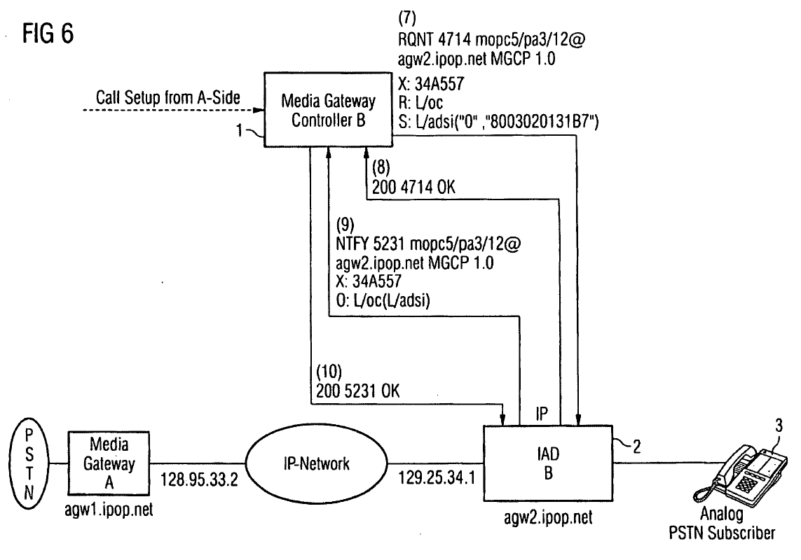

Subsequently, in step (7) in FIG. 6, MGC 1 transfers to IAD 2 a Notification Request with the signal Analog Display Service Interface (adsi) and the event Operation Complete. This signal adsi contains the FSK data for the Calling Line Identification Presentation (CLIP). IAD 2 acknowledges the transfer in step (8). After the FSK-data for the signaling CLIP, which causes the caller's telephone number to appear in the display of the connected telephone, has been transferred from the IAD 2 to the analog subscriber line 3, the message Operation Complete is transferred to MGC 1 in step (9) and its receipt confirmed by MGC 1 in step (10).

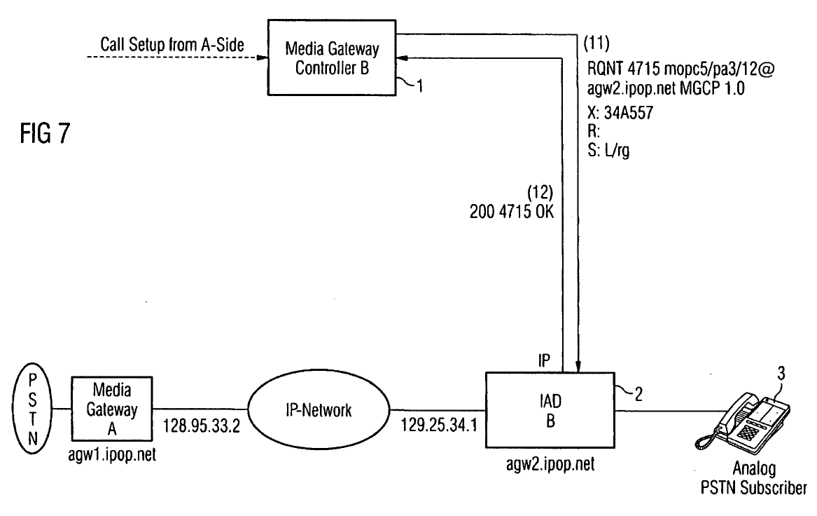

Finally, in FIG. 7 with step (11), a further Notification Request is sent from MGC 1 to IAD 2 with the Ringing signal, followed by the acknowledgement by IAD 2 in step (12). After transfer from IAD 2 to the analog subscriber line 3, the Ringing signal initiates the normal ringing cadence there with 1 sec. ring and 4 sec. idle.

The execution of the invention is not restricted to the exemplary descriptions mentioned above but is also includes a plurality of variations which lie within the framework of specialist activity.

1-13. (canceled)

14. A method for transmitting a subscriber signaling of an analog connection of a public telephone network in an IP network which is connected to the public telephone network via a Media Gateway, the method comprising:
using FSK signals in accordance with European Telecommunications Standard ETSI ETS 300 659 for subscriber signaling to/from an analog connection of the public telephone network over an IP network; and
transmitting the FSK signals in the IP network between a Media Gateway Controller and a Media Gateway using the Media Gateway Control Protocol (MGCP), wherein the MGCP Standard in accordance with “RFC2705” is modified by an encoded Signal Requests Parameter for the transmission of the FSK signals.

15. The method according to claim 14, wherein the Analog Display Service Interface (adsi) signal of the MGCP Standard in accordance with “RFC2705” is used as part of the Signal Requests Parameter.

16. The method according to claim 15, wherein the adsi signal comprises two character strings as parameters.

17. The method according to claim 16, wherein the first specified character string of the adsi signal consists of one character and identifies the alerting method.

18. The method according to claim 17, wherein the first character string of the adsi signal consists of the character “0” and is applicable for transmitting the FSK signaling during the ringing cadence, in which case it requires no alerting sequence.

19. The method according to claim 17, wherein the first character string of the adsi signal consists of the character “D” involving FSK signaling by the DT-AS alerting sequence.

20. The method according to claim 17, wherein the first character string of the adsi signal consists of the character “P” involving FSK signaling by the RP-AS alerting sequence.

21. The method according to claim 17, wherein the first character string of the adsi signal consists of the character “F” and is used for transmitting FSK signaling during the call.

22. The method according to claim 16, wherein
the second character string of the adsi signal comprises the message of the FSK data link layer, beginning with the messages field, and wherein
each byte of the message of the FSK-data link layer is encoded in two hexadecimal characters.

23. The method according to claim 14, wherein the Megaco Standard “RFC3015” or the ITU Standard H.248 are substituting the MGCP Standard.

24. The method according to claim 14, wherein the Megaco Standard “RFC3015” and/or the ITU Standard H.248 are complementing the MGCP Standard.

25. An IP network for transmission of subscriber signaling of an analog connection of a public telephone network, comprising:
a Media Gateway to connect the IP network to the public telephone network; and
a Media Gateway Controller to control the Media Gateway, wherein
communication between the Media Gateway Controller and the Media Gateway is undertaken in the Media Gateway Control Protocol (MGCP), wherein
FSK signals in accordance with the European Telecommunications Standard ETSI ETS 300 659 are used for subscriber signaling to/from the analog connection of the public telephone network over the IP network, are transferred in the IP network in the Media Gateway Control Protocol (MGCP), and wherein
the MGCP Standard in accordance with “RFC2705” is modified by an encoded Signal Requests Parameter for transmitting the FSK signals.

26. The IP network in accordance with claim 25, wherein the IP network is a Voice-over-DSL network.

27. The IP network in accordance with claim 25, wherein the IP network is a Voice-over-Cable network.

28. The IP network in accordance with claim 25, wherein the Media Gateway is an Integrated Access Device.

29. The IP network in accordance with claim 25, wherein a plurality of Media Gateways connects the IP network to the public telephone network

30. The IP network according to claim 25, wherein the Megaco Standard “RFC3015” or the ITU Standard H.248 are substituting the MGCP Standard.

31. The IP network according to claim 25, wherein the Megaco Standard “RFC3015” and/or the ITU Standard H.248 are complementing the MGCP Standard.
